(19) United States
(12) Patent Application Publication
(10) Pub. No.: US 2026/0296889 A1
(43) Pub. Date: Oct. 1, 2026

(54) Methods for Preparing Ferromanganese Oxide, Lithium Manganese Iron Phosphate Material, and Cathode Plate

(71) Applicant: HUBEI HONGRUN HIGH-TECH NEW MATERIALS CO., LTD., Ezhou, Hubei (CN)

(72) Inventors: Junhong HUA, Ezhou (CN); Miyan GUO, Ezhou (CN); Shanwan XU, Ezhou (CN); Jie HAN, Ezhou (CN)

(21) Appl. No.: 18/865,876

(22) PCT Filed: Sep. 26, 2024
(86) PCT No.: PCT/CN2024/121453

§ 371 Date: Apr. 2, 2026

(30) Foreign Application Priority Data
Sep. 24, 2024 (CN) 202411339613.8

(51) Int. Cl. C01B 25/45; C01G 49/00; H01M 4/02; H01M 4/136; H01M 4/58; H01M 10/0525

(52) U.S. Cl. CPC C01B 25/45; C01G 49/0072; H01M 4/136; H01M 4/5825; C01P 2002/72; C01P 2004/03; C01P 2006/40; H01M 2004/028; H01M 10/0525

(57) ABSTRACT

In one aspect, a preparation method for ferromanganese oxide includes the following steps: providing a ferromanganese solution, a complexant solution, and a base solution with a pH value of 11 to 12; mixing the ferromanganese solution, the complexant solution, and the base solution and then performing a first reaction treatment to obtain a first precursor; and subjecting the first precursor to a second reaction treatment to obtain the ferromanganese oxide; wherein the ferromanganese solution includes Fe²⁺ and Mn²⁺, the complexant solution comprises a first complexant, and a ratio of a stability constant of a complex formed by the first complexant with Fe²⁺ to a stability constant of a complex formed by the first complexant with Mn²⁺ is in a range of 10³ to 10⁵.

### CROSS-REFERENCE TO RELATED APPLICATIONS

This application is an U.S. national phase application under 35 U.S.C. § 371 based upon international patent application No. PCT/CN2024/121453, filed on Sep. 26, 2024, which itself claims priority to Chinese patent application No. 2024113396138, filed on Sep. 24, 2024, entitled “FERROMANGANESE OXIDE, AND PREPARATION METHOD AND APPLICATION THEREOF”. The contents of the above identified applications are hereby incorporated herein in their entireties by reference.

### TECHNICAL FIELD

The present application relates to the technical field of lithium ion batteries, and specifically to a ferromanganese oxide, and a preparation method and an application thereof.

### BACKGROUND

Lithium manganese iron phosphate has received widespread attention in the field of lithium ion batteries due to its higher energy density compared to lithium iron phosphate. Currently, the process for preparing lithium manganese iron phosphate mainly involves a ferromanganese oxide route. Methods for preparing ferromanganese oxide in this route include solid-state methods and liquid-phase co-precipitation methods. The liquid-phase co-precipitation methods generally involve dissolving soluble manganese and ferrous sources as raw materials, co-precipitating ferrous ions and manganese ions by a complexant, and then calcining the resulting precipitate to obtain ferromanganese oxide. However, in traditional liquid-phase co-precipitation methods, the co-precipitation effect on manganese and iron is poor, and it is easy to include impurities in the prepared ferromanganese oxide, among other issues.

### SUMMARY

In a first aspect, embodiments of the present application provide a method for preparing a ferromanganese oxide, including:
providing a ferromanganese solution, a complexant solution, and a base solution with a pH value of 11 to 12;
mixing the ferromanganese solution, the complexant solution, and the base solution and then performing a first reaction treatment to obtain a first precursor; and
subjecting the first precursor to a second reaction treatment to obtain the ferromanganese oxide.

The ferromanganese solution includes Fe²⁺ and Mn²⁺.

The complexant solution includes a first complexant. A ratio of a stability constant of a complex formed by the first complexant with Fe²⁺ to a stability constant of a complex formed by the first complexant with Mn²⁺ is in a range of 10³ to 10⁵.

In some of the embodiments, a total concentration of Mn²⁺ and Fe²⁺ in the ferromanganese solution is 0.5 mol/L to 2 mol/L.

In some of the embodiments, a molar ratio of Mn²⁺ to Fe²⁺ in the ferromanganese solution is (3 to 8):(2 to 7).

In some of the embodiments, a concentration of the first complexant in the complexant solution is 0.5 mol/L to 4 mol/L.

In some of the embodiments, the first complexant is selected from ethylenediamine, 2-methyl-8-hydroxyquinaldine, and a combination thereof.

In some of the embodiments, the base solution includes a second complexant; and a concentration of the second complexant in the base solution is 0.5 mol/L to 2 mol/L.

In some of the embodiments, the second complexant is selected from ethylenediamine, 2-methyl-8-hydroxyquinaldine, and a combination thereof.

In some of the embodiments, during mixing the ferromanganese solution, the complexant solution, and the base solution and then performing the first reaction treatment to obtain the first precursor, a protective gas is continuously introduced into the base solution.

In some of the embodiments, the mixing the ferromanganese solution, the complexant solution, and the base solution and then performing the first reaction treatment to obtain the first precursor includes:
mixing the ferromanganese solution, the complexant solution, and the base solution, and then performing a heat preservation treatment to obtain a slurry including the first precursor;
subjecting the slurry to a solid-liquid separation to obtain a solid material; and
subjecting the solid material to a purification treatment to obtain the first precursor.

In some of the embodiments, the ferromanganese solution, the complexant solution, and the base solution are mixed at 60° C. to 90° C. for 1 h to 3 h.

In some of the embodiments, a temperature in the heat preservation treatment of the slurry is 60° C. to 90° C.

In some of the embodiments, a time of the heat preservation treatment of the slurry is 1 h to 3 h.

In some of the embodiments, the subjecting the first precursor to the second reaction treatment to obtain the ferromanganese oxide includes:
subjecting the first precursor to an oxidation and dehydration treatment to obtain a second precursor; and
subjecting the second precursor to a calcination treatment to obtain the ferromanganese oxide.

In these embodiments, after the oxidation and dehydration treatment, i.e., after ferromanganese hydroxide is oxidated and dried, the first precursor is converted into basic ferromanganese oxide as the second precursor.

In some of the embodiments, the ferromanganese solution is prepared by:
dissolving a soluble manganese salt in pure water to prepare a manganese source solution;
dissolving a soluble ferrous salt in pure water to prepare a ferrous source solution; and
mixing the manganese source solution and the ferrous source solution with a molar ratio of manganese element to iron element of (3 to 8):(2 to 7) to obtain the ferromanganese solution.

In some of the embodiments, the soluble manganese salt includes manganese sulfate, manganese chloride, manganese nitrate, or any combination thereof.

In some of the embodiments, the soluble ferrous salt includes ferrous sulfate, ferrous chloride, ferric nitrate, or any combination thereof.

In some of the embodiments, a concentration of the manganese source solution is 0.5 mol/L to 2 mol/L.

In some of the embodiments, a concentration of the ferrous source solution is 0.5 mol/L to 2 mol/L.

In a second aspect, embodiments of the present application provide a ferromanganese oxide, which is prepared by the method for preparing the ferromanganese oxide as described in any of the above embodiments.

In a third aspect, embodiments of the present application provide a lithium manganese iron phosphate material, which is prepared from a raw material including the ferromanganese oxide as described above.

In a fourth aspect, embodiments of the present application provide a cathode plate including a current collector and an active layer located on a surface of the current collector. The active layer includes the lithium manganese iron phosphate material as described above.

In a fifth aspect, embodiments of the present application provide a secondary battery including the cathode plate as described above.

The above descriptions are only an overview of the technical solutions of the present application. In order to have a clearer understanding of the technical means of the present application and implement same according to the contents of the specification, and in order to make the above and other purposes, features, and advantages of the present application more apparent and understandable, the specific embodiments of the present application will be specifically listed below.

### BRIEF DESCRIPTION OF THE DRAWINGS

In order to illustrate the technical solutions in the present application more clearly, the drawings used in the present application will be described briefly. It is evident that the following described figures are merely for some embodiments of the present application, and other figures can be derived from the disclosed figures by those of ordinary skill in the art without any creative effort.

FIG. 1 shows a schematic flowchart of a method for preparing ferromanganese oxide according to embodiments of the present application.

FIG. 2 shows X-Ray diffraction (XRD) results of ferromanganese oxide prepared in Examples 1 to 5 of the present application.

FIG. 3 shows XRD result of ferromanganese oxide prepared in Comparative Example 1 of the present application.

FIG. 4 shows XRD result of ferromanganese oxide prepared in Comparative Example 2 of the present application.

FIG. 5 shows scanning electron microscope (SEM) result of ferromanganese oxide prepared in Example 1 of the present application.

FIG. 6 shows SEM result of a second precursor in Example 1 of the present application.

FIG. 7 shows SEM result of a second precursor in Example 4 of the present application.

FIG. 8 shows SEM result of ferromanganese oxide in Comparative Example 1 of the present application.

FIG. 9 shows SEM result of basic ferromanganese oxide in Comparative Example 2 of the present application.

### DETAILED DESCRIPTION OF THE EMBODIMENTS

The embodiments of the technical solutions of the present application will be described in detail below in conjunction with the accompanying drawings. The following embodiments are only intended to provide a clearer explanation of the technical solutions of the present application, and therefore they are only used as examples rather than as limitations to the scope of protection of the present application.

Unless otherwise defined, all technical and scientific terms used herein have the same meaning as commonly understood by one of ordinary skill in the art to which the present application belongs. The terms used herein in the specification of the present application are for the purpose of describing the specific embodiments only, and are not intended to limit the present application. The terms “include”, “comprise”, and any variations thereof in the specification and claims as well as the foregoing description of drawings in the present application are intended to cover non-exclusive inclusions.

In the description of the embodiments of the present application, the technical terms “first”, “second”, etc. are only used to distinguish between different objects and shall not be understood as indicating or implying the relative importance, nor as implying the quantity, particular order, or primary and secondary relation of the indicated technical features. In the description of the embodiments of the present application, unless otherwise explicitly and specifically defined, “a plurality of” means two or more.

Reference herein to “embodiment” means that a particular feature, structure, or characteristic described in connection with the embodiment can be included in at least one embodiment of the present application. This phrase appeared at various places in the specification does not necessarily refer to the same embodiment, nor are they mutually exclusive independent or alternative embodiments. It can be understood by those skilled in the art, both explicitly and implicitly, that the embodiments described in the present application can be combined with other embodiments.

In the description of the embodiments of the present application, the term “and/or” is merely a description of an association relationship of the associated objects, indicating that three kinds of relationships can exist, for example, A and/or B indicates the existence of A alone, the existence of A and B at the same time, and the existence of B alone. In addition, the character “/” used herein generally indicates that the associated objects before and after are in an “or” relationship.

In the description of the embodiments of the present application, the term “a plurality of” means two or more (including two). Likewise, “a plurality of groups” means two or more groups (including two groups), and “a plurality of plates” means two or more plates (including two plates).

In the description of the embodiments of the present application, the orientation and position relationships indicated by the technical terms “center”, “lengthwise”, “crosswise”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial” and “circumferential”, etc., are based on the orientation or position relationship as shown in the accompanying drawings, it is only for the convenience of describing the embodiments of the present application and simplifying the description, rather than indicating or implying that the device or element referred to thereby must have a specific orientation and be constructed and operated in a specific orientation, and thus it cannot be understood as limitations on the embodiments of the present application.

In the description of the embodiments of the present application, unless otherwise specified and limited, the terms “installation”, “interconnection”, “connection”, “fixation”, and the like should be understood in a broad sense, for example, it can be either fixed connection, or detachable connection, or integrated connection; it can be either mechanical connection or electrical connection; and it can be either direct connection, or indirect connection through intermediate media, or it can be the internal communication between two components or the interaction between two components. For those of ordinary skill in the art, the specific meanings of the above terms in the embodiments of the present application can be understood according to the specific situations.

Currently, the process for preparing lithium manganese iron phosphate mainly involves a ferromanganese oxide route. Methods for preparing ferromanganese oxide in this route include solid-state methods and liquid-phase co-precipitation methods. The liquid-phase co-precipitation methods generally involve dissolving soluble manganese and ferrous sources as raw materials, co-precipitating ferrous ions and manganese ions by a complexant, and then calcining the resulting precipitate to obtain ferromanganese oxide. However, in traditional liquid-phase co-precipitation methods, the co-precipitation effect on manganese and iron is poor, and it is easy to include impurities in the prepared ferromanganese oxide, among other issues.

To solve the technical problems of poor co-precipitation effect on manganese and iron and easy inclusion of impurities in the prepared ferromanganese oxide, the present application provides a ferromanganese oxide and a preparation method thereof, a lithium manganese iron phosphate material, a cathode plate, a secondary battery, and an electric apparatus. In the method for preparing Ferromanganese oxide, the ratio of the stability constant of the complex formed by the first complexant and Fe²⁺ to the stability constant of the complex formed by the first complexant and Mn²⁺, which is in the range of 10³ to 10⁵, results in an effective compensation for the nearly three orders of magnitude difference between the solubility products of Fe(OH)₂ and Mn(OH)₂, so that the co-precipitation effect on manganese and iron can be improved, improving the performance such as product purity of ferromanganese oxide and thus improving the cycling performance and the energy density of the lithium manganese iron phosphate material, the cathode plate, and the secondary battery.

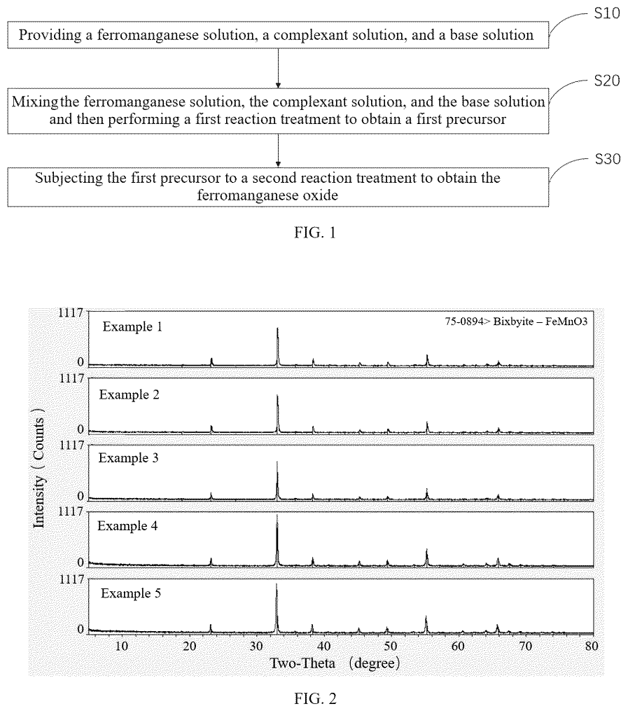

In a first aspect, as shown in FIG. 1, embodiments of the present application provide a method for preparing a ferromanganese oxide, including the following steps:
S10, providing a ferromanganese solution, a complexant solution, and a base solution with a pH value of 11 to 12;
S20, mixing the ferromanganese solution, the complexant solution, and the base solution and then performing a first reaction treatment to obtain a first precursor; and
S30, subjecting the first precursor to a second reaction treatment to obtain the ferromanganese oxide.

The ferromanganese solution includes Fe²⁺ and Mn²⁺.

The complexant solution includes a first complexant. A ratio of a stability constant of a complex formed by the first complexant with Fe²⁺ to a stability constant of a complex formed by the first complexant with Mn²⁺ is 10³ to 10⁵.

In the technical solutions of the embodiments of the present application, in the process of mixing a ferromanganese solution, a complexant solution, and a base solution and then perform the first reaction treatment, the ratio of the stability constant of the complex formed by the first complexant with Fe²⁺ to the stability constant of the complex formed by the first complexant with Mn²⁺, which is in the range of 10³ to 10⁵, results in an effective compensation for the nearly three orders of magnitude difference between the solubility products of Fe(OH)₂ and Mn(OH)₂. Additionally, with the pH value of the base solution between 11 and 12, during the first reaction treatment, manganese ions and ferrous ions in the solution can be controlled through the complexant to uniformly mix iron and manganese elements, which leads to a good co-precipitation effect on manganese ions and ferrous ions, resulting in the first precursor having a high crystal quality with fewer amorphous ferromanganese hydroxide impurities. It should be understood that, the first precursor is a coprecipitate of manganese and ferrous hydroxides. The first precursor is then subjected to the second rection to obtain the ferromanganese oxide. The technical solutions of the embodiments of the present application can improve the co-precipitation effect on manganese and iron, thereby improving the performance such as the product purity of the ferromanganese oxide.

Optionally, the ratio of the stability constant of the complex formed by the first complexant with Fe²⁺ to the stability constant of the complex formed by the first complexant with Mn²⁺ is 10³, 2×10³, 4×10³, 6×10³, 8×10³, 10⁴, 2×10⁴, 4×10⁴, 6×10⁴, 8×10⁴, or 10⁵. Alternatively, the ratio of the stability constant of the complex formed by the first complexant with Fe²⁺ to the stability constant of the complex formed by the first complexant with Mn²⁺ can also be within a range between any two ratios described above.

Optionally, the pH value of the base solution is 11, 11.1, 11.2, 11.3, 11.4, 11.5, 11.6, 11.7, 11.8, 11.9, or 12. Alternatively, the pH value of the base solution can also be within a range between any two pH values described above. It should be understood that, the pH values in the present application are all pH values measured at 25° C.

In some of the embodiments, a total concentration of Mn²⁺ and Fe²⁺ in the ferromanganese solution is 0.5 mol/L to 2 mol/L.

In these embodiments, if the total concentration of Mn²⁺ and Fe²⁺ in the ferromanganese solution is too high, it would be difficult to preserve the ferromanganese solution due to the tendency for crystallization. If the total concentration of Mn²⁺ and Fe²⁺ in the ferromanganese solution is too low, the production levels of the first precursor and the ferromanganese oxide would be not so high with the same volume of the ferromanganese solution, potentially leading to increased manufacturing costs. Optionally, the total concentration of Mn²⁺ and Fe²⁺ in the ferromanganese solution is 0.5 mol/L, 0.6 mol/L, 0.7 mol/L, 0.8 mol/L, 0.9 mol/L, 1 mol/L, 1.1 mol/L, 1.2 mol/L, 1.3 mol/L, 1.4 mol/L, 1.5 mol/L, 1.6 mol/L, 1.7 mol/L, 1.8 mol/L, 1.9 mol/L, or 2 mol/L. Alternatively, the total concentration of Mn²⁺ and Fe²⁺ in the ferromanganese solution can also be within a range between any two concentrations described above.

In some of the embodiments, a molar ratio of Mn²⁺ to Fe²⁺ in the ferromanganese solution is (3 to 8):(2 to 7).

In these embodiments, if the molar ratio of Mn²⁺ to Fe²⁺ in the ferromanganese solution is too high, i.e., if the proportion of manganese is too high, the cycling performance of the subsequently prepared lithium manganese iron phosphate material would be affected. If the molar ratio of Mn²⁺ to Fe²⁺ in the ferromanganese solution is too low, the voltage platform and the energy density of the subsequently prepared lithium manganese iron phosphate material would be affected. Optionally, the molar ratio of Mn²⁺ to Fe²⁺ in the ferromanganese solution is 8:2, 8:3, 8:4, 8:5, 8:6, 8:7, 3:2, 3:2.5, 3:3, 3:3.5, 3:4, 3:4.5, 3:5, 3:5.5, 3:6, 3:6.5, or 3:7. Alternatively, the molar ratio of Mn²⁺ to Fe²⁺ in the ferromanganese solution can also be within a range between any two molar ratios described above.

In some of the embodiments, a concentration of the first complexant in the complexant solution is 0.5 mol/L to 4 mol/L.

In these embodiments, within the above range of the concentration of the first complexant in the complexant solution, a good co-precipitation effect on manganese ions and ferrous ions can be achieved. Optionally, the concentration of the first complexant in the complexant solution is 0.5 mol/L, 1 mol/L, 1.5 mol/L, 2 mol/L, 2.5 mol/L, 3 mol/L, 3.5 mol/L, or 4 mol/L. Alternatively, the concentration of the first complexant in the complexant solution can also be within a range between any two concentrations described above.

In some of the embodiments, the base solution includes a second complexant. A concentration of the second complexant in the base solution is 0.5 mol/L to 2 mol/L. Optionally, the concentration of the second complexant can be 0.6 mol/L, 0.8 mol/L, 1 mol/L, 1.2 mol/L, 1.5 mol/L, 1.6 mol/L, 1.8 mol/L, or any concentration value between 0.5 mol/L and 2 mol/L.

In these embodiments, the addition of the second complexant to the base solution can prevent the direct production of ferromanganese hydroxide due to the direct rection of manganese ions and ferrous ions with sodium hydroxide after the ferromanganese solution is added. With the addition of the second complexant to the base solution, after the ferromanganese solution is added to the base solution, the complexant preferentially reacts with manganese ions and ferrous ions to form a complex, and then hydroxide ions combine with manganese ions and ferrous ions to produce ferromanganese hydroxide as the concentration of sodium hydroxide increases. If the concentration of the complexant in the base solution is too low, the manganese ions and ferrous ions cannot be effectively complexed after the ferromanganese solution is added to the base solution, leading to direct production of ferromanganese hydroxide. This results in a sequential precipitation process, making it difficult to achieve a uniform co-precipitation effect. If the concentration of the complexant in the base solution is too high, too many ferrous ions would be complexed, causing manganese ions to precipitate first, which also hinders the uniform co-precipitation effect. Optionally, the concentration of the second complexant in the base solution is 0.5 mol/L, 0.6 mol/L, 0.7 mol/L, 0.8 mol/L, 1 mol/L, 1.2 mol/L, 1.4 mol/L, 1.5 mol/L, 1.6 mol/L, 1.7 mol/L, 1.8 mol/L, 1.9 mol/L, or 2 mol/L. Alternatively, the concentration of the second complexant in the base solution can also be within a range between any two concentrations described above.

In some of the embodiments, the base solution further includes sodium hydroxide, potassium hydroxide, or a combination thereof to regulate the pH value of the base solution to 11 to 12.

In some of the embodiments, the first complexant is selected from ethylenediamine, 2-methyl-8-hydroxyquinoline, or a combination thereof.

In some of the embodiments, the second complexant is selected from ethylenediamine, 2-methyl-8-hydroxyquinoline, or a combination thereof.

In these embodiments, a ratio of a stability constant of a complex formed by ethylenediamine with Fe²⁺ to a stability constant of a complex formed by ethylenediamine with Mn²⁺ is about 10⁴, and a ratio of a stability constant of a complex formed by 2-methyl-8-hydroxyquinoline with Fe²⁺ to a stability constant of a complex formed by 2-methyl-8-hydroxyquinoline with Mn²⁺ is about 10³, so that ethylenediamine and 2-methyl-8-hydroxyquinoline both can achieve a good co-precipitation effect on manganese ions and ferrous ions.

In some of the embodiments, in the step of mixing a ferromanganese solution, a complexant solution, and a base solution and then perform the first reaction treatment to obtain the first precursor, a protective gas is continuously introduced into the base solution.

In these embodiments, considering that manganese is easily oxidized and then disproportionated into fine particles of manganese dioxide under an alkaline condition, which causes difficult co-precipitation of manganese and iron elements, continuously introducing the protective gas into the base solution in the step of performing the first reaction treatment can reduce the oxidation of manganese, thereby achieving a better co-precipitation effect.

In some of the embodiments, the protective gas includes nitrogen, helium, argon, or any combination thereof.

In some of the embodiments, the step of mixing a ferromanganese solution, a complexant solution, and a base solution and then performing the first reaction treatment to obtain the first precursor includes:
mixing the ferromanganese solution, the complexant solution, and the base solution, and then performing a heat preservation treatment to obtain a slurry including the first precursor;
subjecting the slurry to a solid-liquid separation to obtain a solid material; and
subjecting the solid material to a purification treatment to obtain the first precursor.

In these embodiments, the step of performing the first reaction treatment to obtain the first precursor includes firstly mixing the ferromanganese solution, the complexant solution, and the base solution and then performing the heat preservation treatment. By firstly obtaining the slurry including the first precursor through mixing and heat preservation treatment, amorphous ferromanganese hydroxide can be converted into crystalline ferromanganese hydroxide that can induce manganese ions and ferrous ions in the solution by growing on crystal nucleus thereof, thereby avoiding an excess of amorphous ferromanganese hydroxide.

In some of the embodiments, the ferromanganese solution, the complexant solution, and the base solution are mixed for 1 hour (h) to 3 h at 60° C. to 90° C. Optionally, the ferromanganese solution, the complexant solution, and the base solution can be mixed for a time of 1 h, 1.2 h, 1.4 h, 1.6 h, 1.8 h, 2 h, 2.2 h, 2.4 h, 2.6 h, 2.8 h, or 3 h, or any time between 1 h to 3 h. The ferromanganese solution, the complexant solution, and the base solution can be mixed at 60° C., 62° C., 64° C., 66° C., 68° C., 70° C., 72° C., 74° C., 76° C., 78° C., 80° C., 82° C., 84° C., 86° C., 88° C., or 90° C., or any temperature between 60° C. and 90° C.

In these embodiments, within the above ranges of the mixing temperature and time, the crystal form of the amorphous ferromanganese hydroxide in the slurry can be converted into crystalline ferromanganese hydroxide so that the first precursor can have a better stability. If the mixing temperature is too low, the reaction time as required would be too long. If the mixing temperature is too high, an upper limit of supersaturation of the reaction system would be decreased, and a nucleation rate of the crystal nucleus would be too fast, leading to inconsistent product morphology. Within the above range of the mixing time, the morphology of the precursor can be appropriately regulated by the mixing time. If the mixing time is short, the nucleation rate would be too fast, and the second precursor, basic ferromanganese oxide, as an intermediate product in the second reaction treatment, would have a spherical morphology. If the mixing time is long, the nucleation rate would be slow, and the second precursor, basic ferromanganese oxide, would have a more regular and flaky morphology, which is more beneficial for forming ferromanganese oxide with improved purity and thus lithium manganese iron phosphate material with improved performance.

Exemplarily, taking ethylenediamine as the complexant, during mixing, ferrous ions and manganese ions are firstly complexed and then precipitated according to the following specific chemical reaction equations:

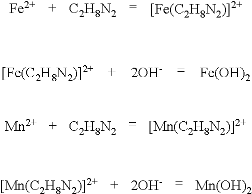

In some of the embodiments, in the step of mixing the ferromanganese solution, the complexant solution, and the base solution and then performing the heat preservation treatment, a pH regulator is used to keep the pH value of the slurry including the first precursor at 11 to 12.

In these embodiments, by using the pH regulator during mixing and heat preservation treatment to keep the pH value of the slurry including the first precursor at 11 to 12, sufficient hydroxide ions can be provided so that a good co-precipitation effect on manganese ions and ferrous ions can be achieved. It should be understood that, the ferromanganese solution, the complexant solution, and the pH regulator are added dropwise to the base solution simultaneously.

In some of the embodiments, the step of mixing the ferromanganese solution, the complexant solution, and the base solution and then performing the heat preservation treatment to obtain the slurry includes:
heating the base solution to 60° C. to 90° C.;
dropwise adding the ferromanganese solution, the complexant solution, and the pH regulator to the heated base solution simultaneously for a time of 1 h to 3 h to obtain a slurry, with the pH value of the slurry kept at 11 to 12; and
after the dropwise adding, subjecting the slurry to the heat preservation treatment at 60° C. to 90° C. for 1 h to 3 h.

In some of the embodiments, the pH regulator includes sodium hydroxide, potassium hydroxide, or a combination thereof.

In some of the embodiments, a temperature in the heat preservation treatment of the slurry is 60° C. to 90° C.

In these embodiments, within the above range of the temperature of the heat preservation treatment of the slurry, the crystal form of the amorphous ferromanganese hydroxide in the slurry can be converted into crystalline ferromanganese hydroxide, so that the first precursor can have a better stability. If the temperature of the heat preservation treatment of the slurry is too low, the time of the heat preservation treatment as required would be too long, affecting the product production efficiency. If the temperature of the heat preservation treatment of the slurry is too high, an upper limit of supersaturation of the reaction system would be decreased, and a nucleation rate of the crystal nucleus would be too fast, leading to inconsistent product morphology, and thus affecting the stability of product. Optionally, the temperature of the heat preservation treatment of the slurry is 60° C., 62° C., 64° C., 66° C., 68° C., 70° C., 72° C., 74° C., 76° C., 78° C., 80° C., 82° C., 84° C., 86° C., 88° C., or 90° C. Alternatively, the temperature of the heat preservation treatment of the slurry can also be within a range between any two temperatures described above.

In some of the embodiments, a time of the heat preservation treatment of the slurry is 1 h to 3 h.

In these embodiments, within the above range of the time of the heat preservation treatment of the slurry, the morphology of the first precursor can be appropriately regulated by the time of the heat preservation treatment. If the time of the heat preservation treatment is short, the conversion of the crystal form of the first precursor would be insufficient, and the second precursor, basic ferromanganese oxide, would have a spherical morphology. If the time of the heat preservation treatment is long, the conversion of the crystal form of the first precursor would be more sufficient, and the second precursor, basic ferromanganese oxide, would have a more regular and flaky morphology. Optionally, the time of the heat preservation treatment is 1 h, 1.2 h, 1.4 h, 1.6 h, 1.8 h, 2 h, 2.2 h, 2.4 h, 2.6 h, 2.8 h, or 3 h. Alternatively, the time of the heat preservation treatment of the slurry can also be within a range between any two times described above.

In some of the embodiments, the step of subjecting the solid material to the purification treatment to obtain the first precursor includes: washing the solid material with water until a conductivity of a sample of the washing water after the solid material is washed is less than or equal to 270 μS/cm, to obtain the first precursor.

Optionally, the conductivity of the sample of the washing water after the solid material is washed can be less than or equal to 250 μS/cm, 252 μS/cm, 254 μS/cm, 256 μS/cm, 258 μS/cm, 260 μS/cm, 262 μS/cm, 264 μS/cm, 266 μS/cm, 268 μS/cm, or 270 μS/cm.

In some of the embodiments, the step of subjecting the first precursor to the second reaction treatment to obtain the ferromanganese oxide includes the following steps:
subjecting the first precursor to an oxidation and dehydration treatment to obtain a second precursor; and
subjecting the second precursor to a calcination treatment to obtain the ferromanganese oxide.

In these embodiments, after the oxidation and dehydration treatment, i.e., after ferromanganese hydroxide is oxidated and dried, the first precursor is converted into basic ferromanganese oxide as the second precursor.

In some of the embodiments, a temperature of the oxidation and dehydration treatment is 90° C. to 99° C.

Optionally, the temperature of the oxidation and dehydration treatment is 90° C., 91° C., 92° C., 93° C., 94° C., 95° C., 96° C., 97° C., 98° C., or 99° C. Alternatively, the temperature of the oxidation and dehydration treatment can also be within a range between any two temperatures described above.

In some of the embodiments, a time of the oxidation and dehydration treatment is 6 h to 12 h.

Optionally, the time of the oxidation and dehydration treatment is 6 h, 6.5 h, 7 h, 7.5 h, 8 h, 8.5 h, 9 h, 9.5 h, 10 h, 11 h, or 12 h. Alternatively, the time of the oxidation and dehydration treatment can also be within a range between any two times described above.

In some of the embodiments, the oxidation and dehydration treatment is performed under an air atmosphere.

In some of the embodiments, a calcination temperature of the calcination treatment is 700° C. to 850° C.

Optionally, the calcination temperature of the calcination treatment is 700° C., 710° C., 720° C., 730° C., 740° C., 750° C., 760° C., 770° C., 780° C., 790° C., 800° C., 810° C., 820° C., 830° C., 840° C., or 850° C. Alternatively, the temperature of the calcination treatment can also be within a range between any two temperatures described above.

In some of the embodiments, a calcination time of the calcination treatment is 2 h to 6 h.

Optionally, the calcination time of the calcination treatment is 2 h, 2.5 h, 3 h, 3.5 h, 4 h, 4.5 h, 5 h, 5.5 h, or 6 h. Alternatively, the time of the calcination treatment can also be within a range between any two times described above.

In some of the embodiments, the calcination treatment is performed under an air atmosphere.

In some of the embodiments, after the second precursor is subjected to the calcination treatment, the resulting product is cooled to 25° C. to 50° C. before discharging.

Optionally, after the second precursor is subjected to the calcination treatment, the resulting product is cooled to 25° C., 30° C., 35° C., 40° C., 45° C., or 50° C. before discharging. Alternatively, a discharging temperature can also be within a range between any two temperatures described above.

In some of the embodiments, the preparation of the ferromanganese solution includes the following steps:
dissolving a soluble manganese salt in pure water to prepare a manganese source solution;
dissolving a soluble ferrous salt in pure water to prepare a ferrous source solution; and
mixing the manganese source solution and the ferrous source solution with a molar ratio of manganese element to iron element of (3 to 8):(2 to 7) to obtain the ferromanganese solution.

In some of the embodiments, the soluble manganese salt includes manganese sulfate, manganese chloride, manganese nitrate, or any combination thereof.

In some of the embodiments, the soluble ferrous salt includes ferrous sulfate, ferrous chloride, ferric nitrate, or any combination thereof.

In some of the embodiments, a concentration of the manganese source solution is 0.5 mol/L to 2 mol/L.

In these embodiments, if the concentration of the manganese source solution is too high, it would be difficult to preserve the manganese source solution due to the tendency of crystallization. If the concentration of the manganese source solution is too low, the production levels of the first precursor and the ferromanganese oxide would be not so high with the same volume of the manganese source solution, potentially leading to increased manufacturing costs. Optionally, the concentration of the manganese source solution is 0.5 mol/L, 0.6 mol/L, 0.7 mol/L, 0.8 mol/L, 1 mol/L, 1.2 mol/L, 1.4 mol/L, 1.5 mol/L, 1.6 mol/L, 1.7 mol/L, 1.8 mol/L, 1.9 mol/L, or 2 mol/L. Alternatively, the concentration of the manganese source solution can also be within a range between any two concentrations described above.

In some of the embodiments, a concentration of the ferrous source solution is 0.5 mol/L to 2 mol/L.

In these embodiments, if the concentration of the ferrous source solution is too high, it would be difficult to preserve the ferrous source solution due to the tendency of crystallization. If the concentration of the ferrous source solution is too low, the production levels of the first precursor and the ferromanganese oxide would be not so high with the same volume of the ferrous source solution, potentially leading to increased manufacturing costs. Optionally, the concentration of the ferrous source solution is 0.5 mol/L, 0.6 mol/L, 0.7 mol/L, 0.8 mol/L, 1 mol/L, 1.2 mol/L, 1.4 mol/L, 1.5 mol/L, 1.6 mol/L, 1.7 mol/L, 1.8 mol/L, 1.9 mol/L, or 2 mol/L. Alternatively, the concentration of the ferrous source solution can also be within a range between any two concentrations described above.

In a second aspect, embodiments of the present application provide a ferromanganese oxide, which is prepared by the method for preparing the ferromanganese oxide described in any one of the above embodiments.

In the technical solutions of these embodiments of the present application, the ferromanganese oxide prepared by the method for preparing the ferromanganese oxide described in any one of the above embodiments contains manganese and iron elements that are uniformly mixed.

In a third aspect, embodiments of the present application provide a lithium manganese iron phosphate material, which is prepared from a raw material including the above ferromanganese oxide.

In these embodiments, the lithium manganese iron phosphate material prepared from the raw material including the above ferromanganese oxide has a good cycling performance and a high energy density.

In some of the embodiments, a method for preparing the lithium manganese iron phosphate material includes the following steps:
mixing and griding a phosphorus source, a lithium source, a carbon source, and the above ferromanganese oxide to obtain a mixture material;
spray-drying the mixture material to obtain a lithium manganese iron phosphate precursor; and
calcining the lithium manganese iron phosphate precursor under a nitrogen atmosphere to obtain the lithium manganese iron phosphate material.

In these embodiments, by preparing the lithium manganese iron phosphate material from the above ferromanganese oxide, the phosphorus source, the lithium source, and the carbon source, the prepared lithium manganese iron phosphate material can have a good cycling performance and a high energy density.

In some of the embodiments, a calcining temperature of the lithium manganese iron phosphate precursor under the nitrogen atmosphere is 650° C. to 750° C., for example, can be 660° C., 670° C., 680° C., 690° C., 700° C., 710° C., 720° C., 730° C., or 740° C., or any temperature value between 650° C. and 750° C.

In some of the embodiments, the phosphorus source includes ammonium dihydrogen phosphate, lithium dihydrogen phosphate, dilithium hydrogen phosphate, or any combination thereof.

In some of the embodiments, the lithium source includes lithium carbonate, lithium hydroxide, lithium oxalate, lithium acetate, or any combination thereof.

In some of the embodiments, the carbon source includes glucose, graphite, sucrose, or any combination thereof.

In these embodiments, no impurity element will be introduced by the phosphorus source, the lithium source, and the carbon source descried above, facilitating the preparation of the lithium manganese iron phosphate material with the high purity.

In a fourth aspect, embodiments of the present application provide a cathode plate including a current collector and an active layer located on a surface of the current collector. The active layer includes the lithium manganese iron phosphate material as described above.

In these embodiments, due to the inclusion of the lithium manganese iron phosphate material as described above, the active layer of the cathode plate has a good electrochemical performance.

In a fifth aspect, embodiments of the present application provide a secondary battery including the cathode plate as described above.

In these embodiments, the secondary battery includes the cathode plate with the active layer that includes the lithium manganese iron phosphate material as described above. As the cathode plate is applied to the secondary battery, the resulting secondary battery also has a comprehensively improved electrochemical performance and can be well applied in a variety of scenarios.

In a sixth aspect, embodiments of the present application provide an electric apparatus including the secondary battery as described above.

The electric apparatus provided in the embodiments of the present application can be, but is not limited to, mobile phones, tablets, notebook computers, electric toys, electric tools, electric bicycles, electric vehicles, steamships, spacecrafts, etc. The electric toys can include fixed or mobile electric toys, such as games consoles, electric vehicle toys, electric steamship toys, electric airplane toys, etc. The spacecrafts can include airplanes, rockets, space shuttles, spaceships, etc.

Some specific examples are described below. It should be noted that the examples described below are exemplary and are only used to illustrate the present application and are not intended to limit the present application. Unless otherwise specified in the examples, any specific techniques or conditions are carried out in accordance with techniques or conditions described in the literatures in the art or as per the product specifications. Unless otherwise noted with the manufacturer, the reagents or instruments used are conventional products that can be purchased commercially.

### I. Preparation Method

### Example 1

### Method for Preparing Ferromanganese Oxide:

### 1. Raw Material Preparation:

(1) Preparation of Manganese Source Solution: manganese sulfate monohydrate was weighed and dissolved in pure water by stirring to prepare a manganese sulfate solution with a concentration of 1.5 mol/L.
(2) Preparation of Ferrous Source Solution: ferrous sulfate heptahydrate was weighed and dissolved in pure water by stirring to prepare a ferrous sulphate solution with a concentration of 1.5 mol/L.
(3) Preparation of Complexant Solution: ethylenediamine as a first complexant was weighed and dissolved in pure water by stirring to prepare a first complexant solution with a concentration of 2 mol/L.
(4) Preparation of Sodium Hydroxide Solution: sodium hydroxide was weighed and dissolved in pure water by stirring to prepare a sodium hydroxide solution with a concentration of 3 mol/L.
(5) Preparation of Ferromanganese Solution: the manganese sulfate solution and the ferrous sulphate solution were weighed and mixed by stirring at a molar ratio of Mn²⁺ to Fe²⁺ of 6:4 and a total concentration of Mn²⁺ and Fe²⁺ of 1 mol/L.

### 2. Synthesis:

(1) Preparation of Base Solution: pure water, a second complexant, and the sodium hydroxide solution were combined to prepare a base solution with a concentration of the second complexant of 1 mol/L and a pH value of 11.5, wherein the second complexant was ethylenediamine.
(2) High-temperature Hydrolysis Synthesis: nitrogen was introduced into a reactor, the base solution was heated to 80° C., and then the ferromanganese solution, the complexant solution, and the sodium hydroxide solution were added dropwise to the base solution through a triple-tube simultaneously, during which the addition time of the ferromanganese solution and the complexant solution was controlled at 2 h, and the pH value in the synthesis was regulated and kept between 11 and 12 using the sodium hydroxide solution until the addition was finished, and finally an heat preservation treatment was performed for 1 h to obtain a slurry containing a first precursor, ferromanganese hydroxide Mn_{0.6}Fe_{0.4}(OH)₂.
(3) Water Washing: after the heat preservation treatment of the slurry containing the first precursor was finished, the slurry was subjected to a solid-liquid separation and the solid material was washed with water until terminal conductivity of water was 260 μS/cm, to obtain a filter cake of the first precursor, ferromanganese hydroxide Mn_{0.6}Fe_{0.4}(OH)₂.
(4) Oxidation and Drying: the filter cake of the first precursor, ferromanganese hydroxide, was placed in an oven to be oxidated and dried at 98° C. under an air atmosphere for 6 h to obtain a second precursor, basic ferromanganese oxide Mn_{0.6}Fe_{0.4}OOH.
(5) Calcination: the second precursor, basic ferromanganese oxide, was calcined at 750° C. under an air atmosphere for 3 h to obtain (Mn_{0.6}Fe_{0.4})₂O₃.

### Example 2

In this example, the method for preparing the ferromanganese oxide was the same or similar to that in Example 1, except that both the first complexant and the second complexant in this example were 2-methyl-8-hydroxyquinoline; in the step of preparation of ferromanganese solution, the molar ratio of Mn²⁺ to Fe²⁺ was 7:3; and the ferromanganese oxide material obtained in the calcination was (Mn_{0.7}Fe_{0.3})₂O₃.

### Example 3

In this example, the method for preparing the ferromanganese oxide was the same or similar to that in Example 1, except that in the step of preparation of complexant solution in this example, both the first complexant and the second complexant were 2-methyl-8-hydroxyquinoline, a concentration of the first complexant was 4 mol/L, and a concentration of the second complexant was 1 mol/L; a concentration of the sodium hydroxide solution was 4 mol/L; in the step of preparation of ferromanganese solution, the molar ratio of Mn²⁺ to Fe²⁺ was 3:7, and a total concentration of Mn²⁺ and Fe²⁺ was 1.5 mol/L; and the material obtained in the calcination was MnFeO₃.

### Example 4

In this example, the method for preparing the ferromanganese oxide was the same or similar to that in Example 3, except that in the step of preparation of ferromanganese sulfate solution, a ratio of manganese to iron was 5:5; and the material obtained in the calcination was MnFeO₃.

### Example 5

In this embodiment, the method for preparing the ferromanganese oxide was the same or similar to that in Example 1, except that in this example, a concentration of the manganese sulfate solution in the preparation of manganese source solution was 1 mol/L, a concentration of the ferrous sulphate solution in the preparation of ferrous source solution was 1 mol/L, both the first complexant and the second complexant were 2-methyl-8-hydroxyquinoline, and the concentration of the sodium hydroxide solution was 2 mol/L; and in the step of preparation of ferromanganese solution, the molar ratio of Mn²⁺ to Fe²⁺ was 5:5, and a total concentration of Mn²⁺ and Fe²⁺ was 0.5 mol/L; and the material obtained in the calcination was MnFeO₃.

### Example 6

In this embodiment, the method for preparing the ferromanganese oxide was the same or similar to that in Example 1, except that in the step of preparation of ferromanganese solution, the ratio of Mn²⁺ to Fe²⁺ was 4:6, and the ferromanganese oxide material obtained in the calcination was (Mn_{0.4}Fe_{0.6})₂O₃.

### Example 7

In this embodiment, the method for preparing the ferromanganese oxide was the same or similar to that in Example 1, except that a concentration of a manganese chloride solution in the preparation of manganese source solution was 0.5 mol/L, a concentration of a ferrous chloride solution in the preparation of ferrous source solution was 0.5 mol/L, a concentration of the first complexant in the complexant solution was 0.5 mol/L, and a total concentration of Mn²⁺ and Fe²⁺ in the ferromanganese solution was 0.5 mol/L; and the pH of the base solution was 11, and a concentration of the second complexant in the base solution was 0.5 mol/L.

### Example 8

In this embodiment, the method for preparing the ferromanganese oxide was the same or similar to that in Example 1, except that a concentration of a manganese nitrate solution in the preparation of manganese source solution was 2 mol/L, a concentration of a ferrous nitrate solution in the preparation of ferrous source solution was 2 mol/L, a concentration of the first complexant in the complexant solution was 4 mol/L, and a total concentration of Mn²⁺ and Fe²⁺ in the ferromanganese solution was 2 mol/L; and the pH of the base solution was 12, and a concentration of the second complexant in the base solution was 2 mol/L.

### Example 9

In this embodiment, the method for preparing the ferromanganese oxide was the same or similar to that in Example 1, except that during the high-temperature hydrolysis synthesis, the base solution was heated to 60° C., the addition time was 3 h, and the heat preservation treatment was performed for 3 h.

### Example 10

In this embodiment, the method for preparing the ferromanganese oxide was the same or similar to that in Example 1, except that during the high-temperature hydrolysis synthesis, the base solution was heated to 90° C., the addition time was 1 h, and the heat preservation treatment was performed for 2 h.

### Example 11

A method for preparing a lithium manganese iron phosphate material:
(1) the ferromanganese oxide prepared in Example 1, ammonium dihydrogen phosphate, lithium carbonate, and glucose were mixed and ground uniformly at a molar ratio of 1:1:1:0.05;
(2) the uniformly mixed materials were spray-dried to remove water to obtain a lithium manganese iron phosphate precursor;
(3) the lithium manganese iron phosphate precursor was calcined under a nitrogen atmosphere to obtain the lithium manganese iron phosphate material.

### Example 12

In this example, the method for preparing the lithium manganese iron phosphate material was the same or similar to that in Example 11, except that in this example, the ferromanganese oxide prepared in Example 2 was used as a raw material.

### Example 13

In this example, the method for preparing the lithium manganese iron phosphate material was the same or similar to that in Example 11, except that in this example, the ferromanganese oxide prepared in Example 3 was used as a raw material.

### Example 14

In this example, the method for preparing the lithium manganese iron phosphate material was the same or similar to that in Example 11, except that in this example, the ferromanganese oxide prepared in Example 4 was used as a raw material.

### Example 15

In this example, the method for preparing the lithium manganese iron phosphate material was the same or similar to that in Example 11, except that in this example, the ferromanganese oxide prepared in Example 5 was used as a raw material.

### Example 16

In this example, the method for preparing the lithium manganese iron phosphate material was the same or similar to that in Example 11, except that in this example, the ferromanganese oxide prepared in Example 6 was used as a raw material.

### Example 17

In this example, the method for preparing the lithium manganese iron phosphate material was the same or similar to that in Example 11, except that in this example, the ferromanganese oxide prepared in Example 7 was used as a raw material.

### Example 18

In this example, the method for preparing the lithium manganese iron phosphate material was the same or similar to that in Example 11, except that in this example, the ferromanganese oxide prepared in Example 8 was used as a raw material.

### Example 19

In this example, the method for preparing the lithium manganese iron phosphate material was the same or similar to that in Example 11, except that in this example, the ferromanganese oxide prepared in Example 9 was used as a raw material.

### Example 20

In this example, the method for preparing the lithium manganese iron phosphate material was the same or similar to that in Example 11, except that in this example, the ferromanganese oxide prepared in Example 10 was used as a raw material.

### Comparative Example 1

### 1. Raw Material Preparation:

(1) Preparation of Manganese Solution: manganese sulfate monohydrate was weighed and dissolved in pure water by stirring to prepare a manganese sulfate solution with a concentration of 1 mol/L.
(2) Preparation of Ferrous Source Solution: ferrous sulfate heptahydrate was weighed and dissolved in pure water by stirring to prepare a ferrous sulphate solution with a concentration of 1 mol/L.
(3) Preparation of Sodium Hydroxide Solution: sodium hydroxide was weighed and dissolved in pure water by stirring to prepare a sodium hydroxide solution with a concentration of 2 mol/L.
(4) Preparation of Ferromanganese Solution: the manganese sulfate solution and the ferrous sulphate solution were weighed and mixed by stirring at a molar ratio of Mn²⁺ to Fe²⁺ of 5:5 and a total concentration of Mn²⁺ and Fe²⁺ of 0.5 mol/L.

### 2. Synthesis:

(1) Preparation of Base Solution: pure water and the sodium hydroxide solution were combined to prepare a base solution with a pH value of 11.5.
(2) High-temperature Hydrolysis Synthesis: the base solution was heated to 60° C., and then the ferromanganese solution and the sodium hydroxide solution were added dropwise to the base solution through a twin-tube simultaneously, during which the addition time of the ferromanganese solution was controlled at 2 h, and the pH value in the synthesis was regulated and kept between 11 and 12 using the sodium hydroxide solution until the addition was finished, and finally an heat preservation treatment was performed for 1 h to obtain a slurry containing a first precursor.
(3) Water Washing: after the heat preservation treatment of the slurry containing the first precursor was finished, the slurry was washed with water until terminal conductivity of water was 260 μS/cm, to obtain a filter cake of the first precursor.
(4) Drying and Calcination: the filter cake of the first precursor was placed in an oven to be oxidated and dried at 98° C. for 6 h and calcined at 750° C. for 3 h to obtain the ferromanganese oxide, MnFeO₃.

### Comparative Example 2

### 1. Raw Material Preparation:

(1) Preparation of Manganese Solution: manganese sulfate monohydrate was weighed and dissolved in pure water by stirring to prepare a manganese sulfate solution with a concentration of 1 mol/L.
(2) Preparation of Ferrous Source Solution: ferrous sulfate heptahydrate was weighed and dissolved in pure water by stirring to prepare a ferrous sulphate solution with a concentration of 1 mol/L.
(3) Preparation of Sodium Hydroxide Solution: sodium hydroxide was weighed and dissolved in pure water by stirring to prepare a sodium hydroxide solution with a concentration of 2 mol/L.
(4) Preparation of Ferromanganese Solution: the manganese sulfate solution and the ferrous sulphate solution were weighed and mixed by stirring at a molar ratio of Mn²⁺ to Fe²⁺ of 6:4 and a total concentration of Mn²⁺ and Fe²⁺ of 1 mol/L
(5) Preparation of Complexant Solution: ammonium hydroxide was weighed and mixed with pure water by stirring at a concentration of ammonium hydroxide of 1 mol/L.

### 2. Synthesis:

(1) Preparation of Base Solution: pure water, a complexant, and the sodium hydroxide solution were combined to prepare a base solution with a concentration of the complexant of 1 mol/L and a pH value of 11.5.
(2) High-temperature Hydrolysis Synthesis: nitrogen was introduced into a reactor, the base solution was heated to 90° C., and then the ferromanganese solution, ammonium hydroxide, and the sodium hydroxide solution were added dropwise to the base solution through a triple-tube simultaneously, during which the addition time of the ferromanganese solution and ammonium hydroxide was controlled at 30 min, and the pH value in the synthesis was regulated and kept between 11 and 12 using the sodium hydroxide solution until the dropwise addition was finished, and finally an heat preservation treatment was performed for 1 h to obtain a slurry containing a first precursor, ferromanganese hydroxide Mn_{0.6}Fe_{0.4}(OH)₂.
(3) Water Washing: after the heat preservation treatment of the slurry containing the first precursor was finished, the slurry was subjected to a solid-liquid separation and the solid material was washed with water until terminal conductivity of water was 260 μS/cm, to obtain a filter cake of the first precursor, ferromanganese hydroxide.
(4) Oxidation and Drying: the filter cake of the first precursor, ferromanganese hydroxide, was placed in an oven to be oxidated and dried at 98° C. under an air atmosphere for 6 h to obtain a second precursor, basic ferromanganese oxide Mn_{0.6}Fe_{0.4}OOH.
(5) Calcination: the second precursor, basic ferromanganese oxide, was calcined at 750° C. under an air atmosphere for 3 h to obtain (Mn_{0.6}Fe_{0.4})₂O₃.

### Comparative Example 3

In this comparative example, the method for preparing the lithium manganese iron phosphate material was the same or similar to that in Example 11, except that in this example, the ferromanganese oxide prepared in Comparative example 1 was used as a raw material.

### Comparative Example 4

In this comparative example, the method for preparing the lithium manganese iron phosphate material was the same or similar to that in Example 11, except that in this example, the ferromanganese oxide prepared in Comparative example 2 was used as a raw material.

### II. Test Method

1. The contents of manganese and iron elements in the ferromanganese oxide were determined by oxidation-reduction titration, and the contents of other impurity elements were determined by inductively coupled plasma atomic emission spectrometry.
2. Performance test of lithium manganese iron phosphate material

The compaction density of the lithium manganese iron phosphate material was determined by pressed-disk technique using a compaction density meter, with a test pressure of 3T and a pressing time of 30 s.

Methods for testing a specific charge capacity, a specific discharge capacity, and a coulombic efficiency were as follows.

The lithium manganese iron phosphate materials prepared in Examples 11 to 20 and Comparative examples 3 to 4 were each mixed with conductive carbon black and a PVDF binder at a mass ratio of 90:5:5, the mixture was coated on an aluminum foil with a thickness of 12 μm, the electrode plate was placed in an oven to dry at 110° C. for 10 h, the dried electrode plate was punched into a cathode disc with a diameter of 15 mm, the cathode disc was roll-pressed to a compaction density of 1.8 g/cm³, a lithium plate with a diameter of 16 mm was used as a counter electrode, an electrolyte was obtained by dissolving 1 mol/L LiPF₆ in EC:EMC:DEC at a volume ratio of 1:1:1, a cell was assembled in a LG2400/1000TS glove box produced by Vigor Gas Purification Technology (Suzhou) Co., Ltd, to obtain a button half-cell, and a rate performance of the button half-cell was tested.

The test is performed using a battery performance test system (model: CT3002A) from Wuhan Land Electronics Co., Ltd. at a test temperature of 25° C., a voltage range of 2V to 3.75V, and a test rate of 0.1 C.

### III. Test Result Analysis for Examples and Comparative Examples

The contents of manganese, iron, and other impurity elements in the ferromanganese oxide prepared in Examples to 10 and Comparative examples 1 to 2 were shown in Table 1 and Table 2 below.

TABLE 1

| Element mass | | Example | Example | Example | Example | Example | Example |
|---|---|---|---|---|---|---|---|
| fraction | | 1 | 2 | 3 | 4 | 5 | 6 |
| Mn | in % | 41.55 | 48.27 | 20.53 | 34.27 | 34.32 | 27.61 |
| Fe | | 27.94 | 20.95 | 49.11 | 34.91 | 34.84 | 42.08 |
| Cd | in | 2.38 | 1.2 | 1.61 | 4.36 | 1.04 | 2.94 |
| Co | ppm | 8.43 | 6.64 | 8.62 | 0.82 | 10.36 | 7.27 |
| Cr | | 36.76 | 51.8 | 61.26 | 64.65 | 50.45 | 58.65 |
| Cu | | 2.02 | 0.38 | 0 | 2.24 | 0 | 0.3 |
| K | | 0 | 0 | 0 | 0 | 0 | 0 |
| Na | | 154.69 | 213.92 | 191.21 | 267.49 | 229.47 | 143.78 |
| Ni | | 26.48 | 21.34 | 30.14 | 4.42 | 38.11 | 32.68 |
| Pb | | 78.47 | 89.98 | 65.76 | 81.67 | 46.36 | 73.25 |
| Ti | | 0 | 1.39 | 0.32 | 1.72 | 2.37 | 1.2 |
| Zn | | 65.44 | 69.52 | 51.98 | 136.88 | 75.03 | 72.14 |

TABLE 2

| Element mass | | Example | Example | Example | Example | Comparative | Comparative |
|---|---|---|---|---|---|---|---|
| fraction | | 7 | 8 | 9 | 10 | Example 1 | Example 2 |
| Mn | in % | 41.48 | 41.2 | 42.03 | 41.52 | 42.92 | 42.88 |
| Fe | | 27.98 | 28.16 | 28.11 | 28 | 26.38 | 26.54 |
| Cd | in | 1.38 | 1.69 | 1 | 1.03 | 1.73 | 0.26 |
| Co | ppm | 7.37 | 7.95 | 7.83 | 7.92 | 8.62 | 8.89 |
| Cr | | 43.98 | 48.16 | 39.8 | 59.5 | 64.84 | 0 |
| Cu | | 1.7 | 4.02 | 4.1 | 2.08 | 0 | 0.74 |
| K | | 0 | 0 | 0 | 0 | 0 | 8.83 |
| Na | | 184.11 | 105.52 | 141.22 | 167.86 | 93.12 | 72.51 |
| Ni | | 26.05 | 27.63 | 24.96 | 27.22 | 16.72 | 37.76 |
| Pb | | 51.33 | 56.98 | 54.52 | 58.57 | 45.3 | 10.55 |
| Ti | | 1.13 | 7.62 | 8.18 | 0 | 0 | 0 |
| Zn | | 57.63 | 57.73 | 57.35 | 68.23 | 53.82 | 90.51 |

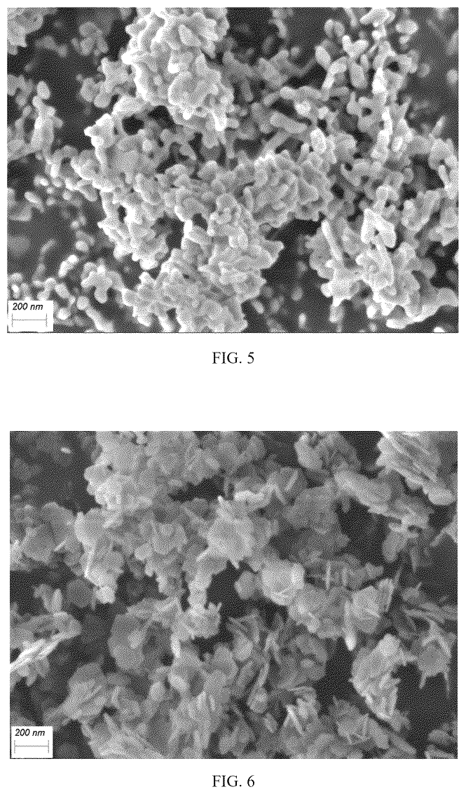

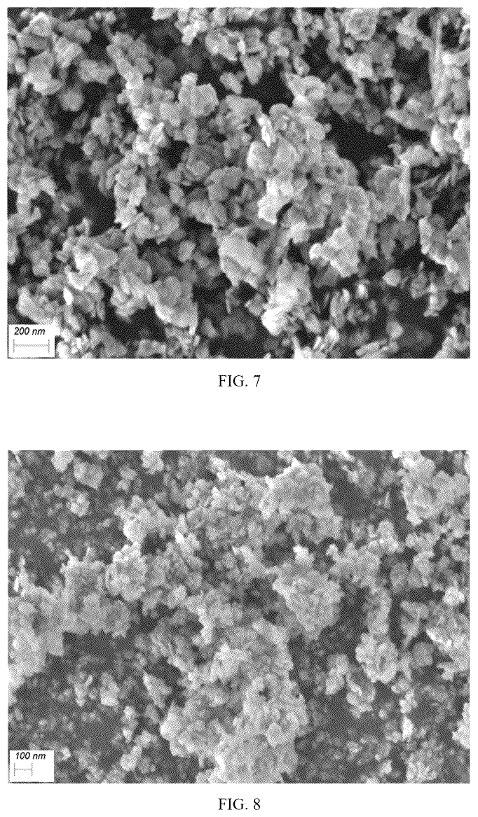

Referring to FIG. 2, FIG. 2 is an XRD diagram of the ferromanganese oxide prepared in Examples 1 to 5 of the present application. It can be seen that there were no impurity peaks of other phases in the test results of all examples. This indicates that through the use of the complexant in the present application, a good co-precipitation effect on manganese and iron can be achieved, resulting in uniform precipitation of manganese and iron, and thus obtaining the ferromanganese oxide with a high purity. Further, referring to FIG. 6 and FIG. 7, it can be seen that compared to Example 1, in Example 4 where the concentration of the ferromanganese sulfate solution was higher, the addition time of the ferromanganese sulfate solution was shorter, and the nucleation rate was faster, the morphology of the second precursor is relatively irregular, with the presence of particles with a non-flaky morphology.

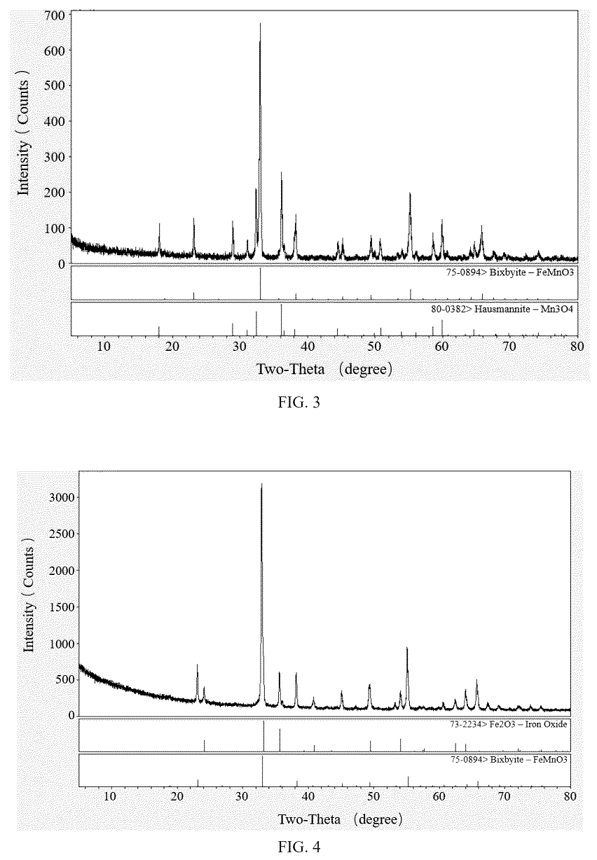

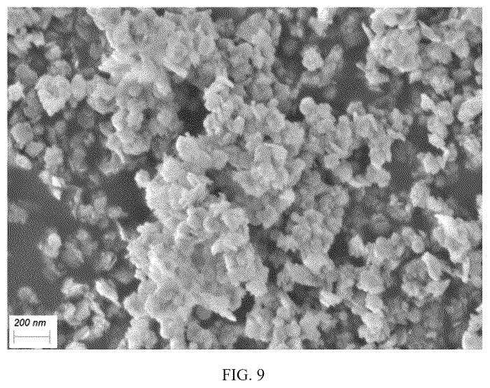

Referring to FIG. 3, in Comparative Example 1, since the precipitation reaction was directly performed under the air atmosphere without using the complexant, divalent manganese and ferrous ions can be partially oxidized in air, and under a high temperature condition, the produced ferromanganese hydroxide can be dehydrated to form a more stable manganese ferrite MnFe₂O₄, which was different from the ferromanganese hydroxide product produced under nitrogen protection. In addition, since precipitation was performed with only hydroxide ions without using the complexant, there was an obvious trimanganese tetraoxide phase in the produced ferromanganese oxide, indicating non-uniform precipitation of manganese and ferrous ions, and resulting in a low purity of the ferromanganese oxide. Referring to FIG. 8, in Comparative Example 1, since the precipitation reaction was directly performed under the air atmosphere without using the complexant, and precipitation was performed with the hydroxide ions only without using the complexant, the morphology of the obtained ferromanganese oxide is irregular.

In Comparative example 2 where ammonium hydroxide was used as the complexant to prepare the ferromanganese hydroxide under the nitrogen atmosphere, since the difference in the complexation ability of the ammonium hydroxide was relatively small, it was difficult to achieve the effective complexation, and the ferrous ions were firstly precipitated to generate ferrous hydroxide, leading to the presence of ferric oxide in the product after oven-drying, calcination, and oxidation. Referring to FIG. 4 and FIG. 9, FIG. 4 was an XRD diagram of the ferromanganese oxide prepared in the Comparative Example 2 of the present application. It can be seen that, in Comparative example 2, the ammonium hydroxide as the complexant can cause the ferrous ions to firstly precipitate to generate ferrous hydroxide, leading to the presence of ferric oxide in the product after oven-drying, calcination, and oxidation.

From the results in Table 1 and Table 2, it can be seen that the mass concentrations of elements such as Cd, Co, Cr, Cu, K, Na, Ni, Pb, Ti, Zn, etc. in the ferromanganese oxide obtained in Examples 1 to 10 were all at ppm level, indicating that the ferromanganese oxide obtained in Examples 1 to 10 had less impurities and high purity.

Test results of the lithium manganese iron phosphate prepared in Examples 11 to 20 and Comparative Examples 3 to 4 were shown in Table 3 below.

TABLE 3

| | | Initial | Initial | |
|---|---|---|---|---|
| | | specific | specific | |
| | | charge | discharge | Initial |
| | Compaction | capacity | capacity | coulombic |
| | density | at 0.1 C | at 0.1 C | efficiency |
| Item | g/cm³ | (mAh/g) | (mAh/g) | (%) |
| Example 11 | 2.334 | 154.97 | 152.27 | 98.26% |
| Example 12 | 2.357 | 154.53 | 151.75 | 98.20% |
| Example 13 | 2.249 | 154.52 | 152.05 | 98.40% |
| Example 14 | 2.266 | 153.36 | 151.34 | 98.68% |
| Example 15 | 2.197 | 154.34 | 151.44 | 98.12% |
| Example 16 | 2.275 | 155.33 | 150.83 | 97.10% |
| Example 17 | 2.371 | 153.85 | 151.37 | 98.39% |
| Example 18 | 2.248 | 148.75 | 146.84 | 98.72% |
| Example 19 | 2.256 | 153.42 | 148.77 | 96.97% |
| Example 20 | 2.354 | 155.97 | 150.86 | 96.72% |
| Comparative | 2.193 | 137.44 | 130.73 | 95.12% |
| Example 3 | | | | |
| Comparative | 2.027 | 144.67 | 142.45 | 98.47% |
| Example 4 | | | | |

From data in Table 3, it can be seen that in Comparative Example 1, since no complexant was used, manganese ions and ferrous ions were precipitated non-uniformly, and there was an obvious trimanganese tetraoxide phase in the prepared ferromanganese oxide, thus causing the compaction density, the specific charge capacity, the specific discharge capacity, and the initial coulombic efficiency of the lithium manganese iron phosphate in Comparative Example 3 prepared by using the ferromanganese oxide prepared in Comparative example 1 as the raw material were all less than those of the lithium manganese iron phosphate material prepared by using the ferromanganese oxide obtained in Examples 1 to 10 as the raw material. In Comparative Example 2 where the ammonium hydroxide was used as the complexant to prepare the ferromanganese hydroxide, since the ferrous ions firstly precipitated to generate ferrous hydroxide, ferric oxide was present in the prepared ferromanganese oxide, thus causing the compaction density, the specific charge capacity, and the specific discharge capacity of the lithium manganese iron phosphate in Comparative example 4 prepared by using the ferromanganese oxide as the raw material were less than those of the lithium manganese iron phosphate material prepared by using the ferromanganese oxide obtained in Examples 1 to 10 as the raw material.

The lithium manganese iron phosphate materials in Examples 11 to 20 that are respectively prepared by using the ferromanganese oxide prepared in Examples 1 to 10 as the raw materials have significantly higher compaction density, specific charge capacity, and specific discharge capacity than those in Comparative Example 3 to 4. Compared with Comparative Examples 1 and 2, in Examples 1 to 10, by using the method for preparing the ferromanganese oxide according to the embodiments of the present application to prepare the ferromanganese oxide, the iron element and manganese element can be uniformly mixed, so that a better co-precipitation effect on manganese and iron can be achieved, and a co-precipitate of manganese and ferrous hydroxides with a high crystal quality and less amorphous ferromanganese hydroxide impurities can be obtained, and the performance such as the product purity of the ferromanganese oxide can be improved. As a result, the lithium manganese iron phosphate material prepared by using the ferromanganese oxide prepared in the embodiments of the present application as the raw material can simultaneously have a high compaction density, a high specific charge capacity, a high specific discharge capacity, and a high initial coulombic efficiency.

It is to be noted that the present application is not limited to the aforementioned embodiments. The above embodiments are only illustrative, and embodiments that have the substantially same composition and play the same acting role as the technical idea within the scope of technical solution of the present application are all included in the technical scope of the present application. In addition, other embodiments constructed by applying various variations that can be thought of by those skilled in the art and by combining some constituent elements of the embodiments without departing from the scope of the main idea of the present application are also included in the scope of the present application.

1. A method for preparing a ferromanganese oxide, comprising:
providing a ferromanganese solution, a complexant solution, and a base solution with a pH value of 11 to 12;
mixing the ferromanganese solution, the complexant solution, and the base solution and then performing a first reaction treatment to obtain a first precursor; and
subjecting the first precursor to a second reaction treatment to obtain the ferromanganese oxide;
wherein the ferromanganese solution comprises Fe²⁺ and Mn²⁺;
wherein the complexant solution comprises a first complexant, and a ratio of a stability constant of a complex formed by the first complexant with Fe²⁺ to a stability constant of a complex formed by the first complexant with Mn²⁺ is in a range of 10³ to 10⁵;
wherein the first complexant is selected from a group consisting of ethylenediamine, 2-methyl-8-hydroxyguinaldine, and a combination thereof.

2. The method for preparing the ferromanganese oxide of claim 1, wherein a total concentration of Mn²⁺ and Fe²⁺ in the ferromanganese solution is 0.5 mol/L to 2 mol/L.

3. The method for preparing the ferromanganese oxide of claim 1, wherein a concentration of the first complexant in the complexant solution is 0.5 mol/L to 4 mol/L.

4. The method for preparing the ferromanganese oxide of claim 1, wherein during the mixing the ferromanganese solution, the complexant solution, and the base solution and then performing the first reaction treatment to obtain the first precursor, a protective gas is continuously introduced into the base solution.

5. The method for preparing the ferromanganese oxide of claim 1, wherein the ferromanganese solution is prepared by:
dissolving a soluble manganese salt in pure water to prepare a manganese source solution;
dissolving a soluble ferrous salt in pure water to prepare a ferrous source solution; and
mixing the manganese source solution and the ferrous source solution with a molar ratio of manganese element to iron element of (3 to 8):(2 to 7) to obtain the ferromanganese solution.

6. The method for preparing the ferromanganese oxide of claim 5, wherein
the soluble manganese salt comprises manganese sulfate, manganese chloride, manganese nitrate, or any combination thereof, and/or
the soluble ferrous salt comprises ferrous sulfate, ferrous chloride, ferric nitrate, or any combination thereof.

7-10. (canceled)

11. The method for preparing the ferromanganese oxide of claim 5, wherein a concentration of the manganese source solution is 0.5 mol/L to 2 mol/L; and/or a concentration of the ferrous source solution is 0.5 mol/L to 2 mol/L.

12. The method for preparing the ferromanganese oxide of claim 1, wherein the base solution comprises sodium hydroxide, potassium hydroxide, or a combination thereof.

13. The method for preparing the ferromanganese oxide of claim 1, wherein the first precursor is crystalline ferromanganese hydroxide.

14. The method for preparing the ferromanganese oxide of claim 1, wherein a molar ratio of Mn²⁺ to Fe²⁺ in the ferromanganese solution is (3 to 8):(2 to 7).

15. The method for preparing the ferromanganese oxide of claim 1, wherein the base solution comprises a second complexant, and a concentration of the second complexant in the base solution is 0.5 mol/L to 2 mol/L.

16. The method for preparing the ferromanganese oxide of claim 15, wherein the second complexant is selected from a group consisting of ethylenediamine, 2-methyl-8-hydroxyquinaldine, and a combination thereof.

17. The method for preparing the ferromanganese oxide of claim 1, the mixing the ferromanganese solution, the complexant solution, and the base solution and then performing the first reaction treatment to obtain the first precursor comprises:
mixing the ferromanganese solution, the complexant solution, and the base solution, and then performing a heat preservation treatment to obtain a slurry comprising the first precursor,
subjecting the slurry to a solid-liquid separation to obtain a solid material, and
subjecting the solid material to a purification treatment to obtain the first precursor.

18. The method for preparing the ferromanganese oxide of claim 17, wherein the ferromanganese solution, the complexant solution, and the base solution are mixed at 60° C. to 90° C. for 1 h to 3 h.

19. The method for preparing the ferromanganese oxide of claim 17, wherein a temperature of the heat preservation treatment of the slurry is 60° C. to 90° C.; and/or a time of the heat preservation treatment of the slurry is 1 h to 3 h.

20. The method for preparing the ferromanganese oxide of claim 1, wherein the subjecting the first precursor to the second reaction treatment to obtain the ferromanganese oxide comprises:
subjecting the first precursor to an oxidation and dehydration treatment to obtain a second precursor, and
subjecting the second precursor to a calcination treatment to obtain the ferromanganese oxide.

21. The method for preparing the ferromanganese oxide of claim 20, wherein the second precursor is basic ferromanganese oxide.

22. The method for preparing the ferromanganese oxide of claim 20, wherein a temperature of the oxidation and dehydration treatment is 90° C. to 99° C., and a time of the oxidation and dehydration treatment is 6 h to 12 h; and/or
a calcination temperature of the calcination treatment is 700° C. to 850° C., and a calcination time of the calcination treatment is 2 h to 6 h.

23. A method for preparing a lithium manganese iron phosphate material, comprising:
preparing a ferromanganese oxide by the method of claim 1; and
preparing the lithium manganese iron phosphate material from the ferromanganese oxide.

24. A method for preparing a cathode plate, comprising:
preparing a ferromanganese oxide by the method of claim 1;
preparing a lithium manganese iron phosphate material from the ferromanganese oxide; and
forming an active layer comprising the lithium manganese iron phosphate material on a surface of a current collector.
